(19) United States
(12) Patent Application Publication
(10) Pub. No.: US 2026/0106811 A1
(43) Pub. Date: Apr. 16, 2026

(54) APPARATUS AND METHOD FOR MANAGING TRANSACTIONS FOR RESOURCE OPTIMIZATION OF CLOUD SERVERS

(71) Applicant: STCLab. Co., Ltd., Seoul (KR)

(72) Inventors: Daebeom JEONG, Yongin-si (KR); Changho HWANG, Yongin-si (KR); Hyung Joon PARK, Seoul (KR)

(73) Assignee: STCLab. Co., Ltd., Seoul (KR)

(21) Appl. No.: 19/255,387

(22) Filed: Jun. 30, 2025

Related U.S. Application Data
(63) Continuation of application No. PCT/KR2023/021769, filed on Dec. 27, 2023.

(30) Foreign Application Priority Data
Dec. 30, 2022 (KR) 10-2022-0190400

(51) Int. Cl. H04L 43/02

(52) U.S. Cl. CPC H04L 43/02

(57) ABSTRACT

The present disclosure relates to an apparatus and method for managing a transaction for resource optimization of a cloud server, which can manage transactions for resource optimization by simultaneously considering both macroscopic and microscopic traffic of the cloud server.

### CROSS-REFERENCE TO RELATED APPLICATIONS

The present application is a Continuation of International Application No. PCT/KR2023/021769 filed on Dec. 27, 2023, which is based upon and claims the benefit of priority to Korean Patent Application No. 10-2022-0190400 filed on Dec. 30, 2022 in the Korean Intellectual Property Office, the entire contents of which are incorporated herein by reference.

### TECHNICAL FIELD

The present disclosure relates to an apparatus and method for managing transactions, and more particularly, to an apparatus and method for managing a transaction for resource optimization of a cloud server.

### BACKGROUND ART

Operators who operate cloud servers (or cloud virtual servers) are divided into CSPs (Cloud Service Providers) and MSPs (Managed Service Providers). CSPs are primary service providers such as Amazon Web Services (AWS), Microsoft, Google, IBM, and Oracle, while MSPs play a role in secondary service distribution and consulting that mediate between CSPs such as Megazone Cloud and customers.

Specifically, in the case of MSPs, when operating Amazon servers, customers must directly set the resource specifications of the cloud server, which is difficult, so they play a role in providing consulting in the middle. In addition, in the case of CSPs, only a guide is provided, and customers must decide on their own.

Therefore, when introducing a cloud server for the first time or when a service is in its early stages, it is difficult for operators to know the appropriate resource specifications. Furthermore, since MSPs cannot help but consider spare resources due to temporary traffic increases, that is, they set resources based only on overall trends or statistics, making it difficult to set proper resources.

Meanwhile, managers of companies providing web services through cloud servers are allocating more resources than required for stability reasons because they need to maintain web servers in an appropriate resource state. However, although this may be desirable in terms of service stability, it is not desirable in terms of cost efficiency because web servers allocated through cloud servers are charged according to resource specifications and operating hours.

As the number of simultaneous users of web servers providing content services such as course registrations, concert reservations, and purchase events increases, the response speed of the server providing the content services is often decreased or the service is interrupted.

Therefore, a technology needs to be developed that can manage transactions for resource optimization by simultaneously considering both macroscopic and microscopic traffic of cloud servers.

### DETAILED DESCRIPTION OF THE INVENTION

### Technical Problem

The present disclosure provides an apparatus and method for managing a transaction for resource optimization of a cloud server that can manage transactions for resource optimization by simultaneously considering both macroscopic traffic and microscopic traffic of the cloud server.

The problems to be solved by the present disclosure are not limited to the problems mentioned above, and other problems not mentioned will be clearly understood by those skilled in the art from the description below.

### Technical Solution

In an aspect of the present disclosure, an apparatus for managing transactions for resource optimization of a cloud server may include a communication module; a storage module configured to store at least one process for managing the transactions; an access management server linked to the cloud server and configured to collect and analyze status information for a specific website according to a preset period to monitor a connection status, provide a monitoring result to a resource optimization server, and activate a management mode based on a management mode activation command being transmitted from the resource optimization server to generate a queue; the resource optimization server configured to detect a degree of traffic increase or decrease within a preset time range based on the connection status to determine whether to perform a control operation for the transaction and perform the control operation, wherein, based on the determination to perform the control operation as the traffic increases, the resource optimization server transmits the management mode activation command to the access management server before performing the control operation; and an operation server configured to perform an operation for managing the transaction based on the at least one process.

Furthermore, in another aspect of the present disclosure, a method for managing transactions for resource optimization of a cloud server may include collecting and analyzing, by an access management server linked to the cloud server, status information for a specific website according to a preset period to monitor a connection status; providing, by the access management server, a monitoring result to a resource optimization server; detecting, by a resource optimization server, a degree of traffic increase or decrease within a preset time range based on the connection status; performing a control operation by determining whether to perform the control operation for the transaction based on a degree of traffic increase or decrease; determining, by the resource optimization server, whether to activate the management mode after determining whether to perform the control operation for the transaction; transmitting a management mode activation command to the access management server based on the resource optimization server determining to activate the management mode; and activating, by the access management server, the management mode to generate a queue.

In addition, a computer program stored in a computer-readable recording medium for executing a method for implementing the present disclosure may be further provided.

In addition, a computer-readable recording medium recording a computer program for executing a method for implementing the present disclosure may be further provided.

### Advantageous Effects of the Invention

According to the present disclosure, it is possible to manage transactions for resource optimization by simultaneously considering both macroscopic traffic and microscopic traffic of a cloud server.

The effects of the present disclosure are not limited to the effects mentioned above, and other effects not mentioned will be clearly understood by those skilled in the art from the description below.

### BRIEF DESCRIPTION OF THE DRAWINGS

FIG. 1 is a diagram illustrating a network structure of a transaction management system for resource optimization of a cloud server according to an embodiment of the present disclosure.

FIG. 2 is a block diagram illustrating a configuration of a management device for managing transactions for resource optimization of a cloud server according to an embodiment of the present disclosure.

FIG. 3 is a flowchart illustrating a method for managing transactions for resource optimization of a cloud server in a management device according to an embodiment of the present disclosure.

FIG. 4 is a diagram specifically illustrating an operation of a management device to collect status information for a specific website according to an embodiment of the present disclosure.

FIG. 5 is a diagram illustrating whether a management device performs a control operation for a transaction of a cloud server according to an embodiment of the present disclosure.

FIG. 6 is a diagram specifically illustrating an operation for controlling a transaction according to whether the traffic increases or decreases for a specific space of a specific website by a management device according to an embodiment of the present disclosure.

FIG. 7 to FIG. 11 are diagrams illustrating an example of a monitoring result being displayed through a display module provided in a provider terminal according to an embodiment of the present disclosure.

FIG. 12 is a diagram illustrating an example of a resource optimization server of a management device controlling the number of users by a specific action unit and allocating resources according to an embodiment of the present disclosure.

### BEST MODE

The advantages and features of the present disclosure, and methods for achieving them, will become clear with reference to the embodiments described in detail below along with the accompanying drawings. However, the present disclosure is not limited to the embodiments disclosed below and may be implemented in various different forms. The present embodiments are merely provided to ensure that the present disclosure is complete, and provided to fully convey the scope of the present disclosure to those skilled in the art to which the present disclosure pertains. The present disclosure is defined only by the scope of the claims.

The terminology used herein is for the purpose of describing embodiments and is not intended to limit the disclosure. As used herein, singular forms also include plural forms, unless specifically stated otherwise in the context. As used in the specification, “comprises” and/or “comprising” does not exclude the presence or addition of one or more other elements in addition to the mentioned elements. Throughout the specification, the same reference numerals refer to the same elements, and “and/or” includes each and every combination of the elements mentioned. Although “first”, “second”, etc. are used to describe various elements, it is to be understood that these elements are not limited by these terms. These terms are merely used to distinguish one element from another. Accordingly, it should be understood that a first element mentioned below may also be a second element within the technical scope of the present invention.

Unless otherwise defined, all terms (including technical and scientific terms) used in this specification may be used with meanings commonly understood by those skilled in the art to which this disclosure pertains. Additionally, terms defined in commonly used dictionaries are not to be interpreted ideally or excessively unless clearly specifically defined.

The same reference numerals refer to the elements throughout the present disclosure. This disclosure describes not all elements of the embodiments, and general descriptions or redundant descriptions in the embodiments in the technical field to which this disclosure belongs are omitted. The term “unit” or “module” used in the specification means a software, hardware component such as an FPGA or an ASIC, and the “unit” or “module” performs certain roles. However, the “unit” or “module” is not limited to software or hardware. The “unit” or “module” may be configured to be in an addressable storage medium and may be configured to play one or more processors. Thus, as an example, the “unit” or “module” includes components such as software components, object-oriented software components, class components, and task components, and processes, functions, properties, procedures, subroutines, segments of program code, drivers, firmware, microcode, circuits, data, databases, data structures, tables, arrays, and variables. The functions provided within the components and “parts” or “modules” may be combined into a smaller number of components and “parts” or “modules” or further separated into additional components and “parts”or “modules”.

Throughout the specification, when a part is said to be “connected” to another part, this includes not only the case where it is directly connected, but also the case where it is indirectly connected, and the indirect connection includes the connection via a wireless communication network.

Also, when a part is said to “include” a component, this does not mean that other components are excluded, unless otherwise specifically stated, but that other components may be included.

Throughout the specification, when a component is said to be “on” another component, this includes not only the case where the component is in contact with the other component, but also the case where another component exists between the two components.

The terms first, second, and the like are used to distinguish one component from another component, and the components are not limited by the aforementioned terms.

A singular expression includes a plural expression unless there is an obvious exception in the description.

The identifiers in each step are used for convenience of description and do not describe the order of each step, and each step may be performed in a different order than the stated order unless the description clearly describes a specific order.

The terms used in the following description are defined as follows.

In describing the present disclosure, it is limited to a management device 300, but it may further include a server, a computer, and/or a portable terminal, or may be in the form of any one of them.

Here, the server is a server that communicates with an external device to process information, and may include an application server, a computing server, a database server, a file server, a game server, a mail server, a proxy server, and a web server.

The computer may include, for example, a notebook, a desktop, a laptop, a tablet PC, a slate PC, and the like equipped with a web browser.

The portable terminal may include, for example, a wireless communication device that ensures portability and mobility, such as a PCS (Personal Communication System), a GSM (Global System for Mobile communications), a PDC (Personal Digital Cellular), a PHS (Personal Handyphone System), a PDA (Personal Digital Assistant), an IMT (International Mobile Telecommunication)-2000, a CDMA (Code Division Multiple Access)-2000, a W-CDMA (W-Code Division Multiple Access), a WiBro (Wireless Broadband Internet) terminal, a smart phone, and all kinds of handheld-based wireless communication devices, as well as wearable devices such as watches, rings, bracelets, anklets, necklaces, glasses, contact lenses, or head-mounted devices (HMDs).

Hereinafter, the operating principle and embodiments of the present disclosure will be described with reference to the attached drawings.

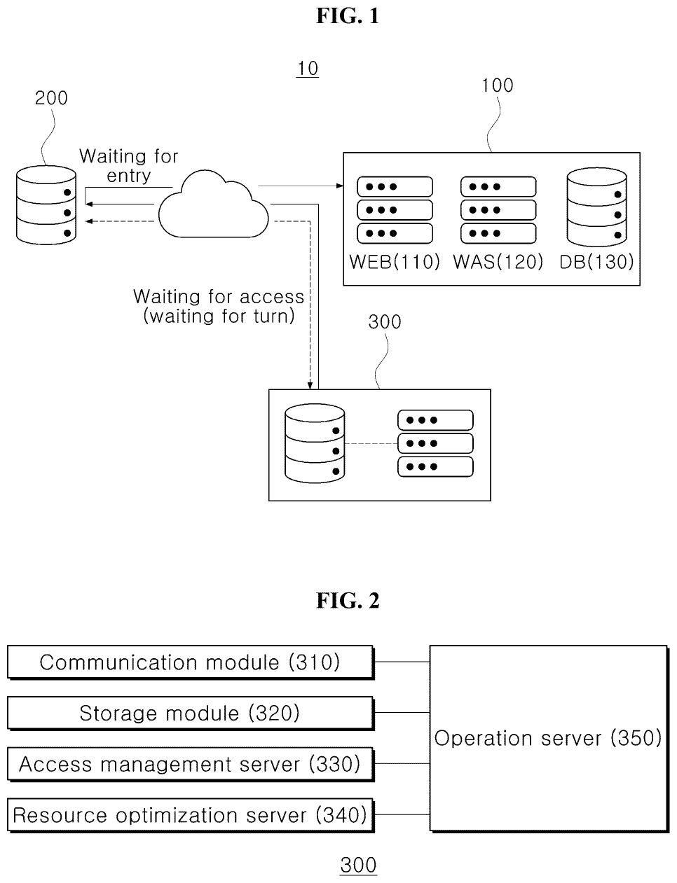

FIG. 1 is a diagram illustrating a network structure of a transaction management system for resource optimization of a cloud server according to an embodiment of the present disclosure.

Referring to FIG. 1, a transaction management system 10 for resource optimization of a cloud server according to an embodiment of the present disclosure may include a system for providing a web service (hereinafter referred to as a ‘web service providing system’ 100), a cloud service providing server (hereinafter referred to as a ‘cloud server’ 200), and a transaction management device 300.

The web service providing system 100 is a system for providing a web service based on a specific web site, and includes a web server 110 that provides a web page composed of HTML (hypertext markup language), a web application server (WAS) 120 that processes an application service for a request message transmitted from the web server 110, and a database DB 130 that stores data that may be provided as a response to a query statement, and provides the web service in a cloud environment (AWS). Here, the web server 110 is a cloud-based server that the cloud server 200 allocates for a specific website, and there may be at least one.

In the case that the number of concurrent users in this web service providing system 100 is excessive, the web server 110 may experience a phenomenon in which the response time is delayed due to insufficient network bandwidth.

The cloud server 200 is a device that allocates and manages resources so that the web service providing system 100 may provide web services in a cloud environment (AWS), and is operated by a cloud operator such as a CSP or MSP.

To this end, the cloud server 200 collects status information of the web service providing system 100 according to a preset period, and may be linked with a service management device 300 to allow users to sequentially enter the web server 110 even in the case that the number of users is excessive.

The management device 300 is linked with the cloud server 200 to provide a transaction management service, and monitors the connection status by collecting status information for a specific web page through the cloud server 200 at a preset period, and detects a traffic increase or decrease based on the connection status confirmed according to the monitoring results, thereby controlling transactions for the cloud server 200.

Specifically, in order to control the transaction of the cloud server 200, in one embodiment, the management device 300 may perform scale-up or scale-down for the specifications of the cloud server 200, or scale-out or scale-in in another embodiment. To this end, the management device 300 may use at least one threshold to perform an operation for controlling the transaction. The operation will be described in detail below with reference to FIG. 6.

At this time, the scale-up or the scale-down may be performed by raising or lowering the specifications of a web server 110 by adjusting the number of RAMs or CPUs allocated within the web server 110, and the scale-out or the scale-in may be performed by physically increasing (out) or decreasing (in) the number of web servers 110. For example, in the case that a surge in users is expected and one web server 110 is previously used, the scale-out may be performed by increasing the number of web servers 110 to 5.

Meanwhile, when performing transaction control, the management device 300 may present or change a resource setting value for the cloud server 200 depending on a degree of authority granted to the management device 300.

For example, in the case that the management device 300 checks the authority granted for the specific website, and as a result of the check, the management device 300 is granted the authority to directly change the resource setting value for the cloud server 200, the management device 300 provides the resource setting value to the cloud server 200 to command resource reset, so that the management device 300 directly controls (changes) the number of RAMs or CPUs of the web server 110 or directly controls (changes) the number of web servers 110.

Meanwhile, in the case that the management device 300 is not granted the authority to directly change the resource setting value for the cloud server 200 as a result of check, resource setting information including the resource setting value may be transmitted to a terminal of the web service provider (hereinafter referred to as the ‘provider terminal’ 140).

The management device 300 may automatically control the number of users allowed to access a specific website application according to a RuleSet setting value.

Meanwhile, in describing FIG. 1, a single of the web server 110, a single of the WAS 120, and a single of the database 130 are illustrated in the web service providing system 100, but this is merely for the convenience of description, and each may be configured with at least one or more.

FIG. 2 is a block diagram illustrating a configuration of a management device for managing transactions for resource optimization of a cloud server according to an embodiment of the present disclosure.

Referring to FIG. 2, the management device 300 for transaction management for resource optimization of a cloud server according to an embodiment of the present disclosure may include a communication module 310, a storage module 320, an access management server 330, a resource optimization server 340, and an operation server 350.

The communication module 310 performs wired or wireless communication with the web server 110, the cloud server 200, and at least one other external device server, and the like. Particularly, when performing wireless communication, the communication module 310 transmits and receives wireless signals in a communication network according to wireless Internet technologies.

The communication module 310 may include one or more components that enable communication with an external device, and may include, for example, at least one of a wired communication module, a wireless communication module, or a short-range communication module, and transmits and receives signals based on this.

Here, the wired communication module may include various wired communication modules such as a Local Area Network (LAN) module, a Wide Area Network (WAN) module, or a Value Added Network (VAN) module, as well as various cable communication modules such as a Universal Serial Bus (USB), a High Definition Multimedia Interface (HDMI), a Digital Visual Interface (DVI), RS-232 (recommended standard), a power line communication, or plain old telephone service (POTS).

The wireless communication module may include a wireless communication module that supports various wireless communication methods such as a WiFi module, a WiBro (Wireless broadband) module, GSM (Global System for Mobile Communication), CDMA (Code Division Multiple Access), WCDMA (Wideband Code Division Multiple Access), UMTS (Universal mobile telecommunications system), TDMA (Time Division Multiple Access), WLAN (Wireless LAN), DLNA (Digital Living Network Alliance), WiBro (Wireless Broadband), WiMAX (World Interoperability for Microwave Access), HSDPA (High Speed Downlink Packet Access), HSUPA (High Speed Uplink Packet Access), LTE (Long Term Evolution), 4G, 5G, and 6G.

The short-range communication module is for short-range communication, and may support short-range communication by using at least one of Bluetooth, RFID (Radio Frequency Identification), IrDA (Infrared Data Association), UWB (Ultra Wideband), ZigBee, NFC (Near Field Communication), Wi-Fi (Wireless-Fidelity), Wi-Fi Direct, or Wireless USB (Wireless Universal Serial Bus) technologies.

Specifically, the communication module 310 collects status information from each of the web server 110 and the cloud server 200 based on wired or wireless communication, generates and transmits resource setting information, and transmits and receives various information with at least one external device.

The storage module 320 stores data and/or various information that support various functions of the management device 300. A plurality of application programs or applications driven by the management device 300, data for the operation of the server 100, and commands may be stored. At least some of these application programs may be downloaded from an external server via wireless communication. Meanwhile, the application programs may be stored in at least one memory equipped in the storage module 320, installed on the management device 300, and driven to perform operations or functions by at least one processor equipped in the operation server 350.

Meanwhile, at least one memory may include at least one type of storage medium among flash memory type, hard disk type, multimedia card micro type, memory of card type (e.g., SD or XD memory, etc.), random access memory (RAM), static random access memory (SRAM), read-only memory (ROM), electrically erasable programmable read-only memory (EEPROM), programmable read-only memory (PROM), magnetic memory, magnetic disk, and optical disk. In addition, the memory may temporarily, permanently, or semi-permanently store information, and may be provided as a built-in or removable type.

The storage module 320 may construct and provide a database for providing a transaction management service based on the cloud server 200, and the database may store basic information, status information, and the like for each of at least one user (customer) who has subscribed to the transaction management service. For this purpose, the storage module 320 may be linked with the cloud server 200. In addition, the storage module 320 may store at least one process for managing the transaction.

The access management server 330 is linked with the cloud server 200 to collect and analyze status information for a specific web page according to a preset period to monitor the connection status, and provides the monitoring result to the resource optimization server 340. In addition, when a management mode activation command is transmitted from the resource optimization server 340, the access management server 330 activates the management mode and generates a queue. That is, while the resource optimization server 340 performs scale-up or scale-out as a control operation for the transaction, the resource optimization server 340 provides a waiting order and a waiting space to the connected users, thereby enabling the traffic to be covered. At this time, the access management server 330 may generate a queue only in the case that the access management server 330 performs a control operation on a transaction as traffic increases, and may not generate a queue in the case that the access management server 330 performs a control operation on a transaction as traffic decreases.

Meanwhile, the access management server 330 may be linked to at least one of preset buttons, pages, or sessions within a specific website, and may perform automatic activation of the management mode only for the linked space, or the access management server 330 may perform automatic activation of the management mode for all spaces where traffic increases or decreases within the specific website.

The access management server 330 may control the number of active users based on a preset threshold after allowing all users requesting entry to a specific space of the website to enter the web service provision system 100 and accepting all of them. For example, the transactions within the preset threshold may be processed for entry into the web service immediately, and the transactions exceeding the preset threshold may be processed for entry automatically after generating a queue and waiting in order. Here, the preset threshold may be the number of action entries allowed.

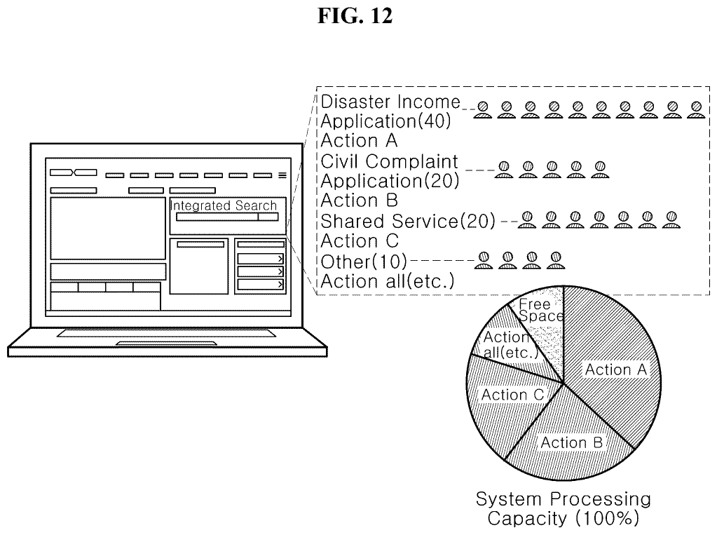

For example, the access management server 330 controls the number of users connected to a specific action unit of a website application and allocates resources. As a result, even in the case that there is a surge in connections to a specific service provided by the specific website, stable connections to other services are available and efficient resource allocation is available. The specific operation will be described below with reference to FIG. 12.

Meanwhile, when the access management server 330 receives a notification from the resource optimization server 340 that all control operations for a transaction have been completed, the access management server 330 terminates, that is, deactivates the management mode and processes traffic based on the resources reset added by the control operation for the transaction. As described above, the management mode is activated only when the control operation for a transaction is performed as the traffic increases, and the notification may be received only when the management mode is activated. That is, the resource optimization server 340 may transmit the notification to the access management server 330 only in the case of performing the control operation for the transaction as the traffic increases.

The resource optimization server 340 checks the connection status based on the monitoring result provided from the access management server 330, and determines whether to perform a control operation for the transaction by detecting a degree of traffic increase or decrease within a preset time range based on the connection status. At this time, the control operation for the transaction may be one of scale-up, scale-out, scale-down, and scale-in.

In the case that the degree of traffic increase is greater than or equal to a preset first threshold, the resource optimization server 340 determines to activate the management mode and transmits a management mode activation command to the access management server 330. Thereafter, when the management mode is activated by the access management server 330, the resource optimization server 340 performs scale-up or scale-out as a control of the transaction for the cloud server 200.

In the case that the degree of traffic decrease is greater than or equal to the preset first threshold, the resource optimization server 340 performs scale-down or scale-in as a transaction control for the cloud server 200.

That is, the resource optimization server 340 transmits the management mode activation command to the access management server 330 only when increasing resources.

Meanwhile, in the case that the resource optimization server 340 determines to perform a control operation for the transaction, the resource optimization server 340 determines a resource setting value for the pre-allocated web server 110 to a specific website, and directly performs the control operation for the transaction using the determined resource setting value depending on the authority, or generates resource setting information including the determined resource setting value and provides transmits the resource setting value to the provider terminal 140, thereby allowing the provider to directly change, that is, reset, the resource. In this case, the resource optimization server 340 performs scale-up or scale-down by adjusting (adding or excluding) the number of RAMs or CPUs of the pre-allocated web servers, and performs scale-out or scale-in by physically adjusting (adding or excluding) the number of pre-allocated web servers.

The operation server 350 may be provided with at least one processor for managing transactions (providing transaction management services), and control all components within the management device 300 to process input or output signals, data, information, and the like, or execute commands, algorithms, and application programs stored in at least one memory to perform various processes, and analyze status information to determine resource setting values according to the connection status and provide them to the provider terminal, or control to reset resources based on the determined resource setting values.

That is, the operation server 350 controls to perform all operations performed in the management device 300 described above based on FIG. 1.

Specifically, the operation server 350 is linked to the cloud server 200 to collect and analyze status information for a specific web page according to a preset period, monitors the connection status, detects traffic increase or decrease based on the connection status confirmed according to the monitoring results, and control to determine whether to perform control on the transaction of the cloud server 200 according to the degree of traffic increase or decrease.

At this time, in the case that the operation server 350 determines to perform a control operation on the transaction, the operation server 350 determines the resource setting value for the cloud server 200 according to whether or not to grant authority or the degree level of granting authority, and controls to directly perform one of scale-up, scale-out, scale-down, and scale-in, or provides presents resource setting information including the determined resource setting values to the provider terminal 140, thereby allowing the provider to perform a reset change on the resource specification of the cloud server 200.

For example, in the case that the management device 300 is granted the authority to directly adjust the resource setting value for the cloud server 200, the determined resource setting value may be provided to the cloud server 200, thereby directly adjusting the number of RAMs or CPUs allocated to a specific website by commanding additional allocation or reduction scale-up or scale-down, or directly adjusting the number of web servers corresponding to a specific website by commanding additional allocation or reduction scale-out or scale-in. On the other hand, in the case that the management device 300 is not granted the authority to directly adjust the resource setting value for the cloud server 200, by transmitting resource setting information including the determined resource setting value to the provider terminal 140 corresponding to a specific website, the web service provider or website manager may selectively change the specifications of the web server 110, that is, the resources allocated to the web server 110, by using the resource setting value through the provider terminal 140. Although not shown in FIG. 1, the provider terminal 140 may be included in the web service providing system 100, and may be at least one terminal preset corresponding to the web service provider.

Meanwhile, as one embodiment, the operation server 350 may activate the management mode only when a traffic increase or decrease is detected for at least one of the preset buttons, pages, and sessions within a specific website, and as another embodiment, the operation server 350 may activate the management mode for a space where a traffic increase or decrease is detected within a specific website. That is, in one embodiment, whether to activate the management mode is determined and performed only for a preset space within the website, and in another embodiment, whether to activate the management mode is determined and performed anywhere in the space where the traffic increase or decrease is detected within the website.

However, FIG. 2 illustrates one embodiment, and the operation server 350 may be configured as a separate device from the management device 300.

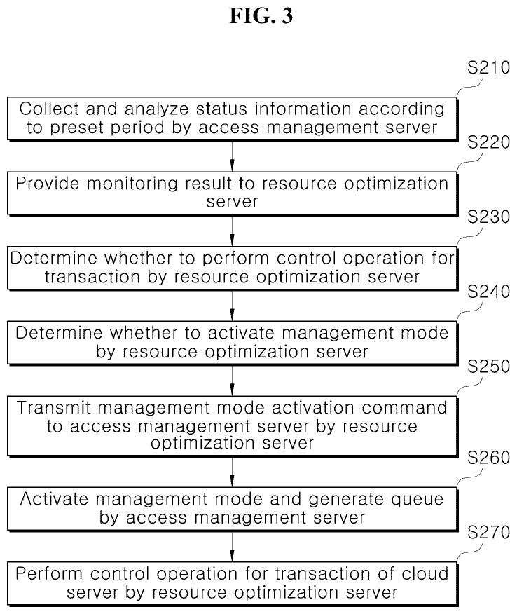

FIG. 3 is a flowchart illustrating a method for managing transactions for resource optimization of a cloud server in a management device according to an embodiment of the present disclosure.

Referring to FIG. 3, the access management server 330 of the management device 300 is linked to the cloud server 200 to receive status information for a specific web page through the communication module 310 according to a preset period, thereby collecting and analyzing the information (step S210), and providing the monitoring result to the resource optimization server 340 (step S220).

Next, the resource optimization server 340 detects the degree of traffic increase or decrease within a preset time range based on the connection status confirmed through the monitoring result, and determines whether to perform the control operation for the transaction of the cloud server 200 (step S230).

Thereafter, when it is determined to perform the control operation for the transaction by step S230, the resource optimization server 340 determines whether to activate the management mode (step S240), and when it is determined to perform the control operation due to the traffic increase, the resource optimization server 340 determines to activate the management mode and transmits the management mode activation command to the access management server 330 (step S250). Next, when the management mode activation command is transmitted from the resource optimization server 340, the access management server 330 activates the management mode to generate a queue to process traffic (step S260), and the resource optimization server 340 performs the control operation for the transaction of the cloud server 200 (step S270). In this case, step S260 is performed while the control of the transaction is performed by the resource optimization server 340. In FIG. 3, steps S260 and S270 are sequentially performed, but this is only for the convenience of description, and they may be performed simultaneously.

Meanwhile, in step S240, when determining whether to activate the management mode, the resource optimization server 340 may determine to activate the management mode only for at least one of the buttons, pages, and sessions set within the specific website, and may automatically activate the management mode for a space where a traffic increase or decrease is detected within the specific website. That is, the web service provider may set the transaction control to be performed only for at least one of the specific buttons, pages, and sessions that generate a lot of traffic, but may also set the transaction control to be performed among the buttons, pages, and sessions that are not set to perform the transaction control in the case that the degree of traffic increase or decrease exceeds the preset threshold range. At this time, in the case that multiple web servers 110 are allocated, the threshold range may be set differently according to the characteristics of each web server.

Meanwhile, steps S250 to S260 are operations that are performed only when the control operation is performed due to the traffic increase, and are operations that are omitted when the control operation is performed due to the traffic decrease. That is, in the case that the resource optimization server 340 determines not to activate the management mode at step S240, the resource optimization server 340 immediately proceeds to step S270 and performs the control operation.

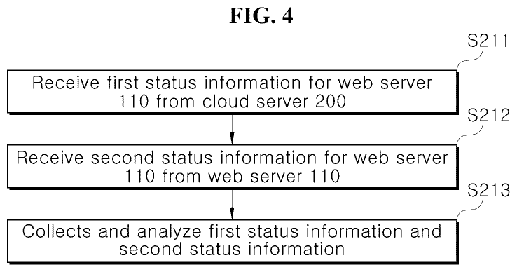

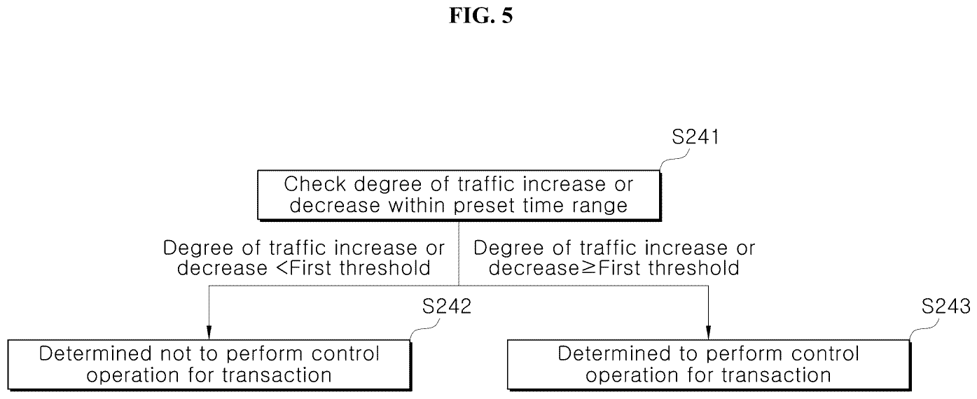

FIG. 4 is a diagram specifically illustrating an operation of a management device to collect status information for a specific website according to an embodiment of the present disclosure.

Referring to FIG. 4, the management device 300 receives first status information for the web server 110 from the cloud server 200 (step S211) and receives second status information for the web server 110 itself from the web server 110 (step S212). At this time, FIG. 4 is merely an embodiment, and the management device 300 may perform steps S211 and S212 simultaneously, or may perform step S212 before step S211, and the order of performing them is not limited.

Meanwhile, the first status information includes system status information and application information that may be confirmed by utilizing basic information provided by the cloud server 200 to the web server 110, and may include, for example, CPU usage, memory, instance shutdown, and the like In addition, the second status information includes service experience information of a user who wants to access the web server 110, and may include at least one of access request information of a user terminal who wants to access a web page, queue information, service experience performance indicator, loading time for each page, or loading and completion time.

Next, the management device 300 collects and analyzes the first status information and the second status information (step S213).

Accordingly, the management device 300 may check whether the traffic is increased or decreased based on the analysis result in step S220 of FIG. 3, and may determine an optimal resource setting value close to the maximum traffic state based on the information collected from the first status information and the second status information to control the transaction, or may provide resource setting information including the optimal resource setting value.

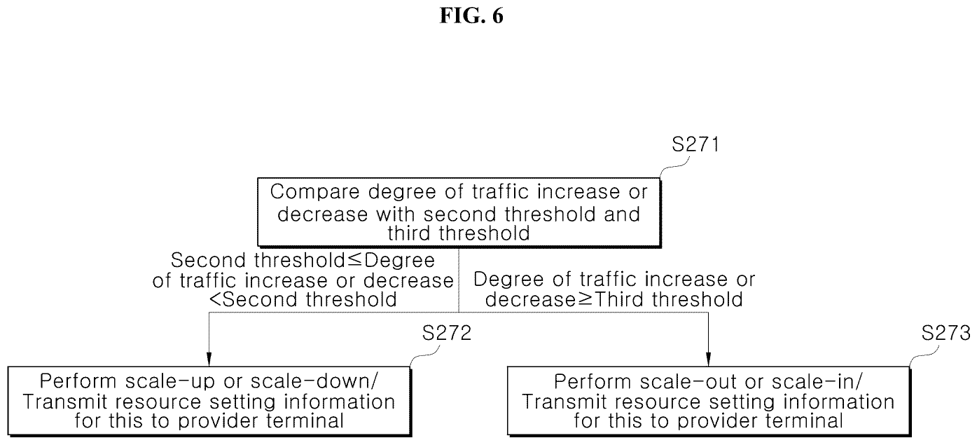

FIG. 5 is a diagram illustrating whether a management device performs a control operation for a transaction of a cloud server according to an embodiment of the present disclosure, the operation may be performed by the resource optimization server 340 of the management device 300, and may be an embodiment of step S230 of FIG. 3.

Referring to FIG. 5, the resource optimization server 340 checks the degree of traffic increase or decrease within a preset time range based on a connection status (step S241).

As a result of the check by step S241, in the case that the degree of traffic increase or decrease is less than the preset first threshold, it is determined not to perform the control operation for the transaction, so that traffic is processed while maintaining the existing resource setting value (step S242).

Meanwhile, as a result of the check by step S241, in the case that the degree of traffic increase or decrease is greater than or equal to the preset first threshold, it is determined to perform the control operation for the transaction (step S243).

Here, the first threshold may be set based on the specifications corresponding to a specific website, that is, in the case that the traffic volume is within the specifications, the existing state is maintained, and in the case that the traffic volume exceeds the specifications, the management mode is activated to change reset the specifications.

FIG. 6 is a diagram specifically illustrating an operation for controlling a transaction according to whether the traffic increases or decreases for a specific space of a specific website by a management device according to an embodiment of the present disclosure, and this operation is performed by the resource optimization server 340 of the management device 300, and may be an embodiment of step S270 of FIG. 3.

Referring to FIG. 6, the resource optimization server 340 compares the degree of traffic increase or decrease with a preset second threshold and a preset third threshold (step S271).

In the case that the degree of traffic increase or decrease is greater than or equal to the preset second threshold and less than or equal to the preset third threshold as a result of the comparison by step S271, scale-up or scale-down is directly performed or resource setting information including a resource reset value for the scale-up or scale-down is transmitted to the provider terminal (step S272).

Meanwhile, in the case that the degree of traffic increase or decrease is greater than or equal to the preset third threshold as a result of the comparison by step S271, scale-out or scale-in is directly performed or resource setting information including a resource reset value for the scale-out or scale-in is transmitted to the provider terminal (step S273).

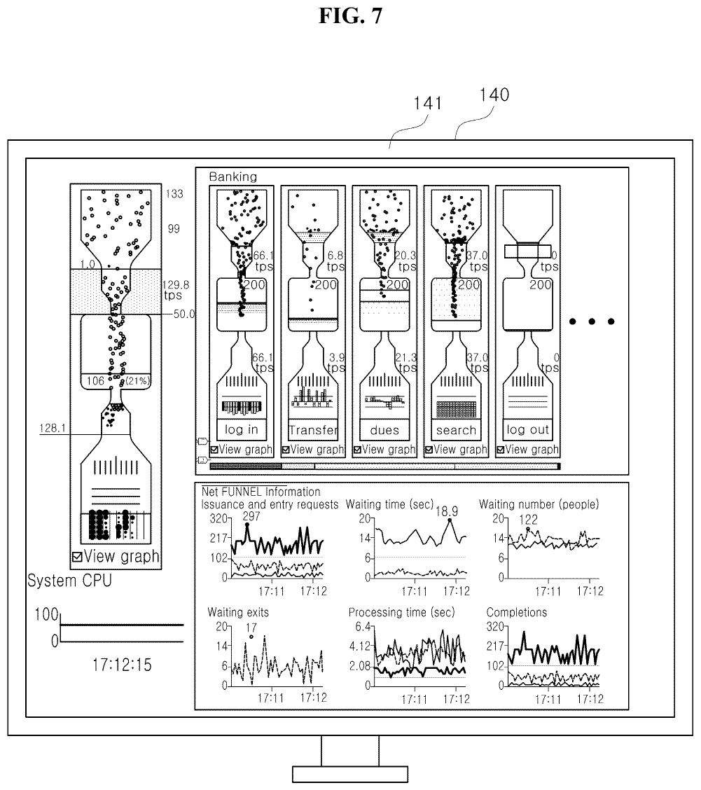

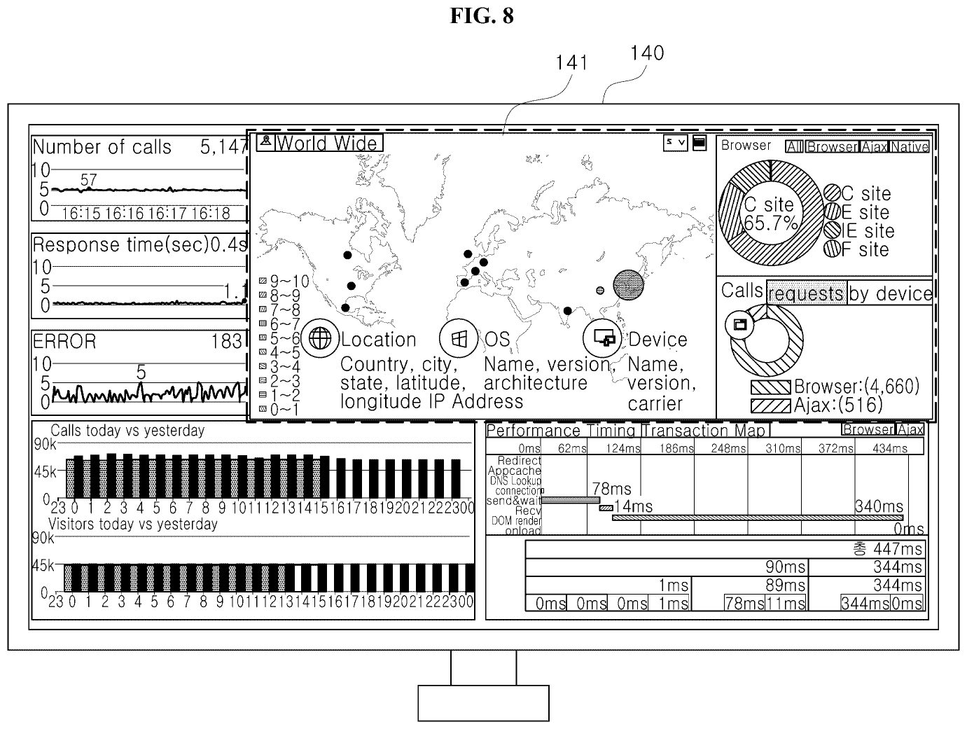

FIG. 7 to FIG. 11 are diagrams illustrating an example of a monitoring result being displayed through a display module provided in a provider terminal according to an embodiment of the present disclosure.

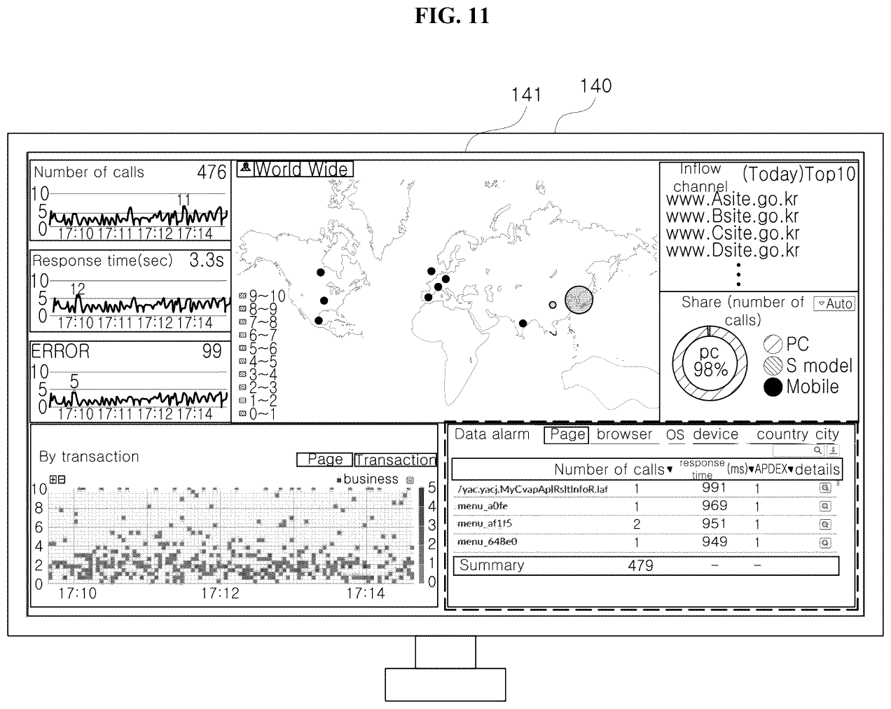

Referring to FIG. 7 and FIG. 11, the provider terminal 140 may display a user interface (UI) for providing a monitoring result, resource allocation information, and the like through a display module 141. At this time, the monitoring result may be based on various information generated by the access management server 330 of the management device 300 by collecting and analyzing status information.

At this time, the display module 141 may include at least one of a liquid crystal display (LCD), a thin film transistor-liquid crystal display (TFT LCD), an organic light-emitting diode (OLED), a flexible display, and a three-dimensional display (3D display). Some of these display modules may be configured as transparent or light-transmitting so that the outside may be viewed through them. This may be referred to as a transparent display module, and a representative example of the transparent display module may include TOLED (Transparent OLED), and the like.

Specifically, the management device 300 may provide various service status information based on the actual number of users in real time, and the provider terminal 140 may display various information provided by the management device 300 through the display unit 141 so that the provider may check it.

For example, as shown in FIG. 6, the result of monitoring service status information based on the actual number of users for a specific website in real time may be provided, or as shown in FIG. 7, the result of monitoring various statistical information on the access environment of the final user for a specific website in real time may be provided.

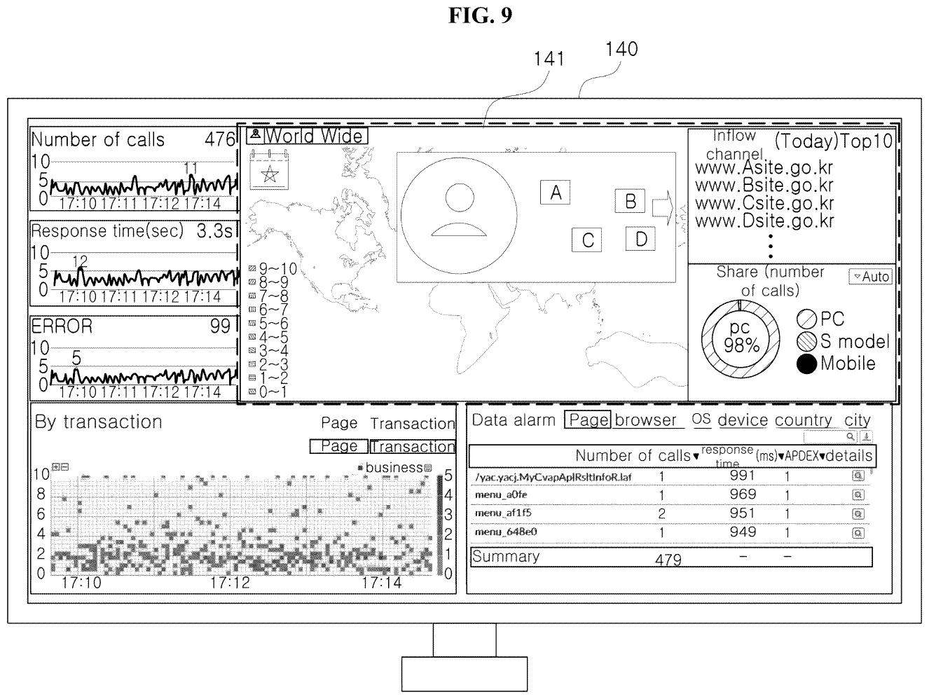

In addition, as shown in FIG. 9, by enabling the final user for a specific website to check the path through which the final user entered the web service based on the URL of the previous site, it is possible to monitor how people accessed the specific website and whether marketing is appropriately conducted.

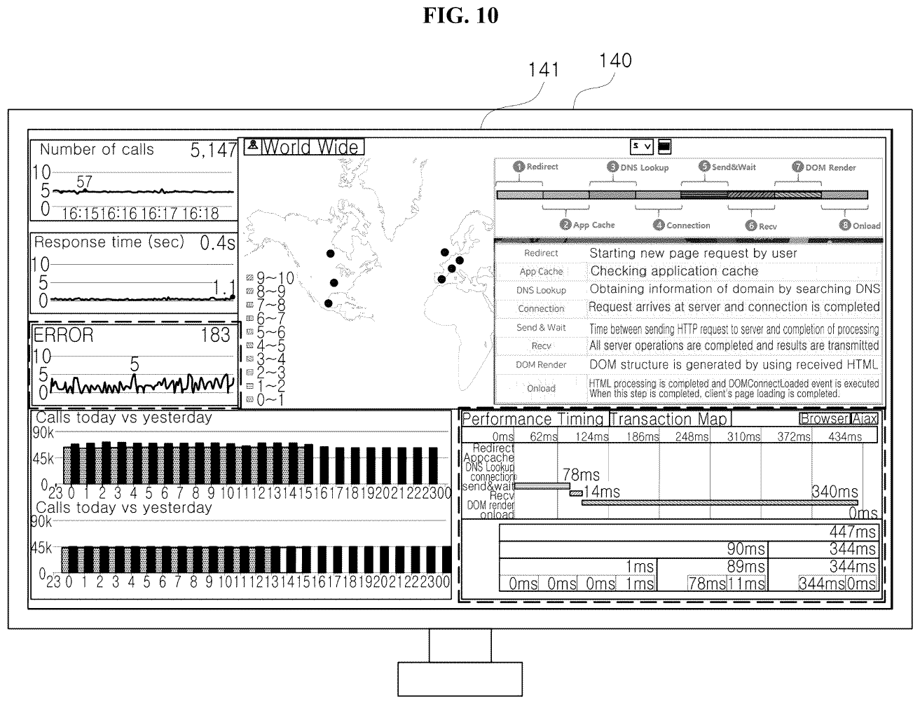

Furthermore, as shown in FIG. 10, the service response time of the user may be divided into the operation steps of the browser as a monitoring result and checked. That is, by providing statistical figures for the number of URI errors as well as the distribution by processing time of transactions requests, traces profiled transactions, and exception handling, it is possible to understand the reasons and causes of service performance from the perspective of the final user.

In addition, as shown in FIG. 11, as a monitoring result, it is possible to provide real-time information on which web pages are frequently called and how fast or slow the response time is through data alarms, and through this, it is possible to provide a ‘performance index (e.g., ApDex)’ as a customer satisfaction measurement index of the website application.

Meanwhile, the provider terminal 140 may be a computer, a UMPC (Ultra Mobile PC), a workstation, a netbook, a PDA (Personal Digital Assistants), a portable computer, a web tablet, a wireless phone, a mobile phone, a smart phone, a pad, a smart watch, a wearable terminal, an e-book, a PMP (portable multimedia player), a portable game console, a navigation device, a black box or digital camera, other mobile communication terminal, and the like, which may install and execute multiple application programs (i.e., applications) desired by the administrator. That is, the provider terminal 140 may be provided in various forms, and is not limited to the forms of the terminals illustrated in FIGS. 6 and 7.

FIG. 12 is a diagram illustrating an example of a resource optimization server of a management device controlling the number of users by a specific action unit and allocating resources according to an embodiment of the present disclosure.

Referring to FIG. 12, the number of users is independently controlled by setting the number of allowed action entries for each of four actions (Action A, Action B, Action C, and Action all (Other)) for a disaster income application, a civil complaint application, a shared service, and other services within the system processing capacity allocated to the specific website application. At this time, the number of allowed action entries for each action may be set differently.

The above-described program may include codes coded in a computer language such as C, C++, JAVA, or machine language that may be read by the processor (CPU) of the computer through the device interface of the computer so that the computer reads the program and executes the methods implemented as the program. These codes may include functional codes related to functions that define the necessary functions for executing the above methods, and may include control codes related to execution procedures necessary for the processor of the computer to execute the above functions according to a predetermined procedure. In addition, these codes may further include memory reference-related codes regarding which location address of the internal or external memory of the computer should be referenced for additional information or media necessary for the processor of the computer to execute the above functions. In addition, in the case that the processor of the computer needs to communicate with any other computer or server located remotely to execute the above functions, the codes may further include communication-related codes regarding how to communicate with any other computer or server located remotely using the communication module of the computer, and what information or media should be sent and received during the communication.

The medium in which data is stored means a medium that semi-permanently stores data and may be read by a device, rather than a medium that stores data for a short period of time, such as a register, cache, or memory. Specifically, examples of the medium in which the program is stored include, but are not limited to, ROM, RAM, CD-ROM, magnetic tape, floppy disk, optical data storage device, and the like. That is, the program may be stored in various recording media on various servers that the computer may access or in various recording media on the user's computer. In addition, the medium may be distributed to computer systems connected to a network, so that computer-readable code may be stored in a distributed manner.

The steps of the method or algorithm described in connection with the embodiments of the present disclosure may be implemented in hardware. It may be implemented directly, implemented as a software module executed by hardware, or implemented by a combination of these. The software module may reside in Random Access Memory (RAM), Read Only Memory (ROM), Erasable Programmable ROM (EPROM), Electrically Erasable Programmable ROM (EEPROM), Flash Memory, hard disk, a removable disk, CD-ROM, or any other form of computer-readable recording medium well known in the art to which the present disclosure pertains.

Although the embodiments of the present disclosure have been described above with reference to the attached drawings, those skilled in the art will understand that the present disclosure may be implemented in other specific forms without changing the technical spirit or essential characteristics thereof. Therefore, it should be understood that the embodiments described above are illustrative in all respects and not restrictive.

1. An apparatus for managing transactions for resource optimization of a cloud server, comprising:
a communication module;
a storage module configured to store at least one process for managing the transactions;
an access management server linked to the cloud server and configured to collect and analyze status information for a specific website according to a preset period to monitor a connection status, provide a monitoring result to a resource optimization server, and activate a management mode based on a management mode activation command being transmitted from the resource optimization server to generate a queue;
the resource optimization server configured to detect a degree of traffic increase or decrease within a preset time range based on the connection status to determine whether to perform a control operation for the transaction and perform the control operation, wherein, based on the determination to perform the control operation as the traffic increases, the resource optimization server transmits the management mode activation command to the access management server before performing the control operation; and
an operation server configured to perform an operation for managing the transaction based on the at least one process.

2. The apparatus according to claim 1, wherein the resource optimization server is configured to:
when determining whether to perform the control operation for the transaction,
based on the degree of traffic increase or decrease being less than a preset first threshold, determine not to activate the management mode to maintain an existing resource setting value, and
based on the degree of traffic increase or decrease being greater than or equal to the preset first threshold, determine to perform the control operation.

3. The apparatus according to claim 2,
wherein the resource optimization server is configured to directly perform the control operation or provide resource setting information for controlling the transaction to a provider terminal depending on whether authorization is granted, and
wherein the status information includes first status information confirmed by basic information provided by the cloud server to the specific website and second status information collected directly from a pre-allocated web server to the specific website.

4. The apparatus according to claim 3, wherein the resource optimization server is configured to:
based on the degree of traffic increase being greater than or equal to the present first threshold, determine to activate the management mode and transmit the management mode activation command to the access management server.

5. The apparatus according to claim 4, wherein the resource optimization server is configured to:
based on the degree of traffic increase being greater than or equal to the preset second threshold and less than a preset third threshold, perform scale-up directly or transmit the resource setting information including a resource reset value for the scale-up to the provider terminal, and
based on the degree of traffic increase being greater than or equal to the preset third threshold, perform scale-out directly or transmit the resource setting information including a resource reset value for the scale-out to the provider terminal,
wherein the scale-up is performed by adjusting a number of RAMs or CPUs of the pre-allocated web server, and
wherein the scale-out is performed by physically adjusting a number of the pre-allocated web servers.

6. The apparatus according to claim 3, wherein the resource optimization server is configured to:
based on the degree of traffic decrease being greater than or equal to the preset second threshold and less than the preset third threshold, perform scale-down directly or transmit the resource setting information including the resource reset value for the scale-down to the provider terminal, and
based on the degree of traffic decrease being greater than or equal to the preset third threshold, perform scale-in directly or transmit the resource setting information including the resource reset value for the scale-in to the provider terminal,
wherein the scale-down is performed by adjusting a number of RAMs or CPUs of the pre-allocated web server, and
wherein the scale-in is performed by physically adjusting a number of the pre-allocated web servers.

7. The apparatus according to claim 3, wherein the second status information includes at least one of access request information of an access terminal attempting to access the specific website, queue information, a service perception performance indicator, or a loading and completion time for each page.

8. The apparatus according to claim 5, wherein the access management server is configured to:
automatically activate the management mode to generate a queue while the resource optimization server performs the scale-up or the scale-out based on the management mode activation command being received from the resource optimization server, and based on the scale-up or the scale-out being completed, process the traffic based on the RAM or the CPU additionally allocated through the scale-up or the web server additionally allocated through the scale-out, and deactivate the management mode.

9. The apparatus according to claim 5, wherein the access management server is configured to:
activate the management mode only based on the traffic increase or decrease is detected for at least one of a preset button, a page, or a session within the specific website, or activate the management mode for a specific space within the specific website where the traffic increase or decrease is detected.

10. A method for managing transactions for resource optimization of a cloud server performed by an apparatus, comprising:
collecting and analyzing, by an access management server linked to the cloud server, status information for a specific website according to a preset period to monitor a connection status;
providing, by the access management server, a monitoring result to a resource optimization server;
detecting, by a resource optimization server, a degree of traffic increase or decrease within a preset time range based on the connection status;
performing a control operation by determining whether to perform the control operation for the transaction based on a degree of traffic increase or decrease;
determining, by the resource optimization server, whether to activate the management mode after determining whether to perform the control operation for the transaction;
transmitting a management mode activation command to the access management server based on the resource optimization server determining to activate the management mode; and
activating, by the access management server, the management mode to generate a queue.
